(19) United States
(12) Patent Application Publication
(10) Pub. No.: US 2020/0368646 A1
(43) Pub. Date: Nov. 26, 2020

(54) ARRANGEMENT OF A FILTER PLATE FOR A FILTER PRESS AND OF A SEALING DEVICE AND FILTER PLATE

(71) Applicant: JVK Filtration Systems GmbH, Georgensgmund (DE)

(72) Inventors: Bernhard SALBAUM, Rottenbach (DE); Manfred P. HERMANN, Nurnberg (DE)

(73) Assignee: JVK Filtration Systems GmbH, Georgensgmund (DE)

(21) Appl. No.: 16/966,362

(22) PCT Filed: Jan. 31, 2019
(86) PCT No.: PCT/EP2019/052426

§ 371 Date: Jul. 30, 2020

(30) Foreign Application Priority Data
Feb. 1, 2018 (DE) 20 2018 100 564.2

(51) Int. Cl. B01D 25/21; B01D 25/28

(52) U.S. Cl. CPC B01D 25/215; B01D 25/164; B01D 25/285

(57) ABSTRACT

An arrangement of a filter plate for a filter press and of a sealing device. The filter plate has a contact surface for contact with another filler plate, which extends in parallel to a plane formed by the filter plate, and at least one channel opening for forming a channel. The channel opening passes through the filter plate perpendicularly to the plane. Furthermore, it is delimited by a channel surface of the filter plate. The filter plate has an annular recess with a first annular boundary surface. The sealing device has an elastic ring seal and a clamping ring, wherein the elastic ring seal has a second annular boundary surface which corresponds to the first annular boundary surface, and the clamping ring can be inserted into the annular recess such that the elastic ring seal is clamped between the clamping ring and the first annular boundary surface.

The present invention relates to an arrangement of a filter plate for a filter press and of a sealing device. The filter plate has a contact surface for contact with a further filter plate which extends in parallel to a plane formed by the filter plate. Furthermore, the filter plate has at least one channel opening for forming a channel, wherein the channel opening passes through the filter plate perpendicularly to the plane formed by the filter plate and is delimited by a channel surface of the filter plate. Furthermore, the invention relates to a filter plate.

It is known to form a filter pack for a filter press, said filter pack consisting of several filter plates arranged in pairs side by side. Filter chambers are formed between the filter plates in each case. For this purpose, the filter plates have a central filter surface and a thicker sealing edge surrounding the central filter surface. In the filter press, the filter plates can be moved away from and towards each other, whereby the filter chambers can be opened and closed.

Each filter chamber usually has at least one inlet channel and one outlet channel. The suspension to be filtered, which is also referred to as turbidity, flows into the filter chamber via the inlet. The suspension is then filtered by means of a filter cloth, wherein the solids are retained in the filter chamber by the filter cloth, such that a so-called filter cake is formed. The filtrate freed from the solids is discharged from the filter chamber via the outlet channel.

A membrane filter press is known from WO 2004/043569 A2, in which several membrane filters are arranged side by side and membrane-free filter plates are arranged between them. The filter plates are clamped between a head piece and an end piece during operation and are designed in such a way that a filter space is arranged between them. A thicker sealing edge is formed on the outside of each filter plate, where adjacent filter plates abut each other. A filtrate channel is formed in the corner region of the filter plate. For this purpose, channel openings are provided in adjacent filter plates in the region of the sealing edge, which form aligned channel surfaces. A filter cloth is attached radially inside the filtrate channel and extends into the filter chamber. The edge region of the filter plate surrounding the filtrate channel has an annular groove with a dovetail-shaped cross-section, in which a sealing ring is inserted to seal the filtrate channel. The inlet channel formed by adjacent filter plates can also be sealed in a similar way.

When using such filter plates in a filter press, the problem arises that, in particular at higher temperatures of the supplied suspension in the region of a channel formed by the adjacent filter plates, in particular in the region of the inlet channel, it results in breaks in the groove into the channel opening. The annular projection formed between the groove and the channel breaks off in certain regions.

The object of the present invention is therefore to create an arrangement of a filter plate for a filter press and of a sealing device as well as a filter plate in which, in the region of the sealing of a channel formed by several filter plates, no damage to the filter plate occurs during operation in a filter press.

According to the invention, this object is solved by an arrangement having the features of claim 1 and a filter plate having the features of claim 12. Advantageous designs and developments emerge from the dependent claims.

The arrangement according to the invention is characterised in that the filter plate has an annular recess with a first annular boundary surface at the transition from the channel surface to the contact surface, and the sealing device has an elastic ring seal and a clamping ring. Here, the elastic ring seal has a second annular boundary surface which corresponds to the first annular boundary surface. Furthermore, the clamping ring is designed to be inserted into the annular recess in such a way that the elastic ring seal is clamped between the clamping ring and the first annular boundary surface of the filter plate.

It has been found that, in particular in the region of the inlet channel, solids of the suspension supplied under pressure are pressed into the groove formed in the edge region of the filter plate surrounding the channel. Due to the constantly applied closing pressure between the sealing ring and the groove, these solids are pressed into the groove. In particular at higher temperatures, these pressed-in solids can cause the groove to break into the channel. Such breaks occur in particular when the sealing edge is not covered by the filter cloth.

The sealing device of the arrangement according to the invention has the advantage that no more solids can penetrate between a groove and a seal. The clamping ring presses the elastic ring seal against the first annular boundary surface of the filter plate and clamps it in such a way that no more solids can penetrate in the region between the clamping ring and the first annular boundary surface of the filter plate.

However, even if very small solids were to penetrate into the interface between the clamping ring and the elastic ring seal or between the elastic ring seal and the first annular boundary surface of the filter plate, this would not cause the filter plate to break in the region around the channel surface, even at high temperatures. Unlike with known seals, no fragile projection is formed between a groove and the channel opening.

Finally, the arrangement according to the invention has the advantage that both the clamping ring and the elastic seal ring can be replaced. Therefore, all boundary surfaces between the clamping ring, the ring seal and the filter plate can be cleaned. Furthermore, different clamping rings can be used. By way of example, the material of the clamping ring can be adapted to the use of the filter plate in the filter press. By way of example, the pressure at which a suspension is introduced into the channel can be taken into account. Furthermore, the temperatures and solids occurring in the suspension can be taken into account in terms of type and size when selecting the appropriate clamping ring and also when selecting the elastic ring seal.

According to an embodiment of the arrangement according to the invention, the first annular boundary surface has a first partial surface which runs parallel to the plane formed by the filter plate. Furthermore, the first annular boundary surface has a second partial surface which runs perpendicularly to the plane formed by the filter plate. The recess is thus substantially rectangular, in particular square. At the transition from the channel surface to the contact surface, in particular the annular edge normally formed between these two surfaces is cut out by a recess with a rectangular, in particular square, cross-section. In this way, the annular recess with the rectangular or square cross-section arises. Advantageously, such a recess does not create the risk of regions of the filter plate near the channel surface or the contact surface breaking away. Nevertheless, in the case of the arrangement according to the invention, it is possible to use this recess for a seal between adjacent filter plates. The elastic ring seal can namely be clamped into the recess by means of the clamping ring.

According to a development of the arrangement according to the invention, a groove is formed in the second partial surface, said groove extending into the filter plate. In the case of the elastic ring seal, a corresponding rib in particular is formed which engages in the groove in order to hold the elastic ring seal in the recess in the axial direction of the channel opening, i.e. in a direction perpendicular to the plane formed by the filter plate. However, this groove differs from a conventional dovetail groove. It can have a much smaller depth, since the recess also provides further boundary surfaces outside the groove for the elastic ring seal to contact the filter plate. The groove should only secure the elastic ring seal against movement in the axial direction. Furthermore, the groove is arranged in such a way that the entry into the groove has no joint at the contact surface, such that there is no risk of solid particles, for example of a suspension applied under pressure, being able to be penetrate into the groove. Finally, the groove is oriented parallel to the contact surface in the direction of its depth, i.e. parallel to the plane formed by the filter plate, and not perpendicular to the contact surface as in a conventional groove for a sealing ring.

According to a further embodiment of the arrangement according to the invention, the elastic ring seal has a third annular boundary surface with first latching means. The third annular boundary surface is arranged facing away from the second annular boundary surface. Furthermore, the clamping ring has a fourth annular boundary surface with second latching means. Here, the fourth annular boundary surface faces the third annular boundary surface of the elastic ring seal. The fourth annular boundary surface corresponds in particular to the third annular boundary surface. The geometry of the boundary surface of the ring seal, which faces the clamping ring, thus corresponds to the geometry of the boundary surface of the clamping ring, which faces the boundary surface of the ring seal. In this way, the clamping ring can clamp the elastic ring seal in such a way that the ring seal can exert a sealing effect on the contact surface for contact with another filter plate. The sealing device is coupled to the filter plate in such a way that there is no risk of the filter plate breaking.

The third annular boundary surface of the elastic ring seal has in particular a third partial surface which is aligned perpendicularly to the plane formed by the filter plate. The first latching means of the ring seal preferably have latching lugs which are formed by the third partial surface and which hold the clamping ring in the recess in the axial direction of the channel opening. Advantageously, the elastic ring seal is held in the filter plate in the axial direction by the rib engaging in the groove of the filter plate and the clamping ring is held in the filter plate in the axial direction by the latching detents of the ring seal. In this way, the clamping ring with the ring seal can be held securely in the recess, wherein it is still possible for both the clamping ring and the ring seal to be replaced.

Furthermore, the third annular boundary surface of the elastic ring seal has a fourth partial surface which is aligned in parallel to the plane formed by the filter plate. In the case of the fourth partial surface, the first latching means can have teeth. These teeth enable a particularly good sealing effect at the interface with the clamping ring. In the region of the teeth, the clamping ring can also have corresponding teeth. However, this is not necessary. The clamping ring can also have a flat partial surface in this region.

According to a development of the arrangement according to the invention, the elastic ring seal accommodated in the recess protrudes with a sealing projection beyond the contact surface of the filter surface. When the filter plate is used in a filter press, this sealing projection is pressed against the sealing edge of the adjacent filter plate, whereby the channel formed by the channel openings at the contact surfaces between two filter plates is sealed.

Furthermore, one end face of the elastic ring seal accommodated in the recess and one side face of the clamping ring can be aligned with the channel surface. The channel surface of the filter plate can thus be continued by the end face of the ring seal and the side face of the clamping ring without forming projections in the channel formed by the channel surface. In this way, it is advantageously prevented that solids in the liquid guided by the channel, i.e. in particular solids in a supplied suspension, get caught on projections of the channel.

The channel opening of the filter plate is in particular part of an inlet and/or outlet channel. Via such an inlet channel, the suspension to be filtered is fed to a filter chamber which is formed between two filter plates. The filtrate is led out of the filter plate via the outlet channel.

The ring seal can in particular consist of an elastomer. The clamping ring is in particular rigid. It can consist of a plastic or a metal, in particular steel. The material of the ring seal and the clamping ring can be adapted to the use of the filter plate in the filter press in order to seal the channel appropriately.

When the filter plate is used in a filter press, a filter cloth is attached to the filter plate or clamped between two filter plates. In particular, the filter cloth does not cover the contact surface of the filter plate, which is formed at the sealing edge of the filter plate. The filter cloth therefore does not cover the region of the contact surface surrounding the channel opening.

The invention further relates to a filter plate for a filter press with a contact surface for contact with a further filter plate, which extends parallel to a plane formed by the filter plate. The filter plate has at least one channel opening for forming a channel, wherein the channel opening passes through the filter plate perpendicular to the plane formed by the filter plate and is delimited by a channel surface of the filter plate. According to the invention, the filter plate has an annular recess with a first annular boundary surface at the transition from the channel surface to the contact surface.

The filter plate according to the invention can be used in particular with a sealing device, as described above. The filter plate thus has the same advantages as the arrangement according to the invention.

In particular, the first annular boundary surface of the filter plate has a first partial surface which runs in parallel to the plane formed by the filter plate. It also has a second partial surface which runs perpendicularly to the plane formed by the filter plate. The recess thus has a rectangular, in particular square, cross-section. It is inserted at the edge which forms the transition from the channel surface to the contact surface without the recess.

According to a development of the filter plate according to the invention, a groove is formed at the second partial surface, which extends into the filter plate. In particular, the direction of the depth of the groove is aligned parallel to the contact surface.

According to a development of the filter plate according to the invention, an incision is formed in the second partial surface at the transition to the contact surface. This incision is in particular square in cross-section.

The invention is now explained by means of an exemplary embodiment with reference to the drawings.

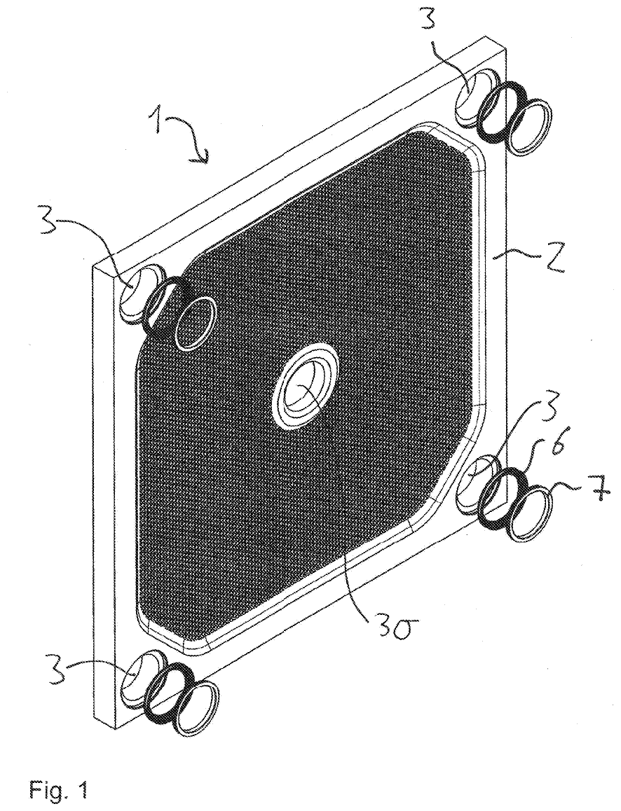

FIG. 1 shows a perspective view of an exemplary embodiment of the arrangement of a filter plate having a sealing device according to the invention,

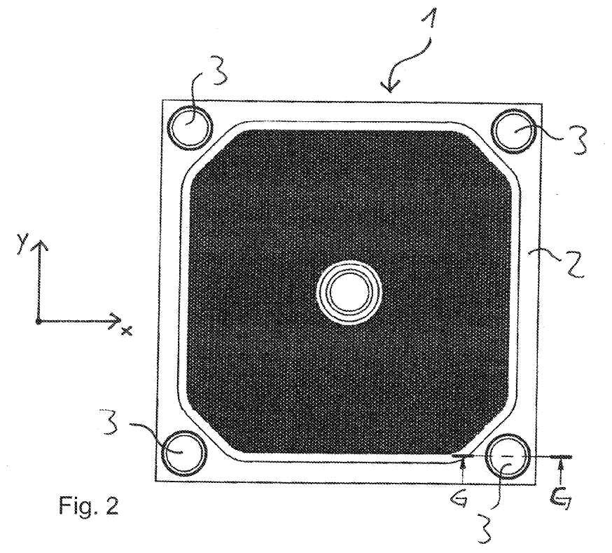

FIG. 2 shows a plan view of the exemplary embodiment of the arrangement according to the invention,

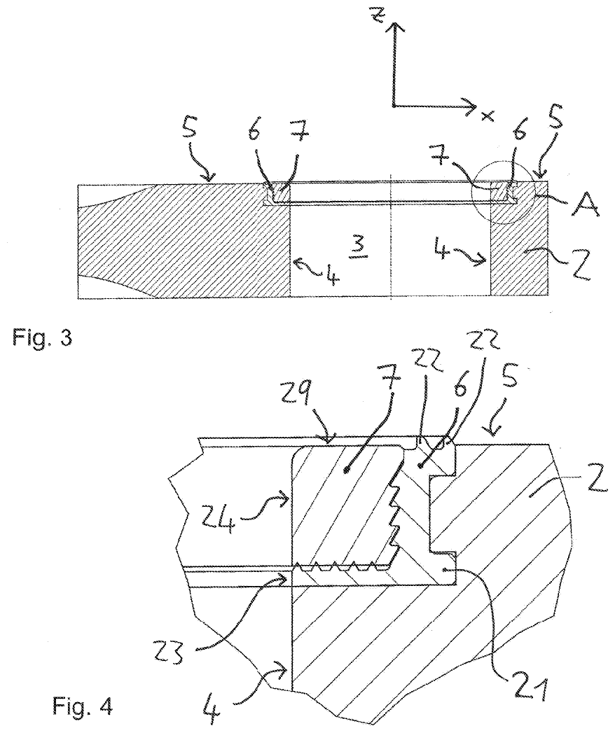

FIG. 3 shows a sectional view along G-G of FIG. 2,

FIG. 4 shows the detailed view A of FIG. 3,

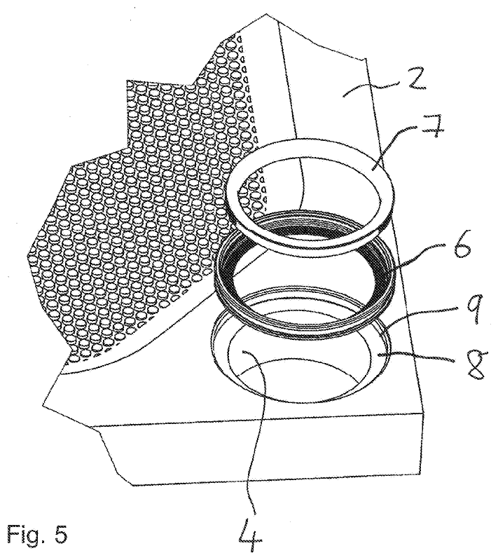

FIG. 5 shows a perspective detailed view of the sealing device in connection with the channel opening of the filter plate according to the exemplary embodiment,

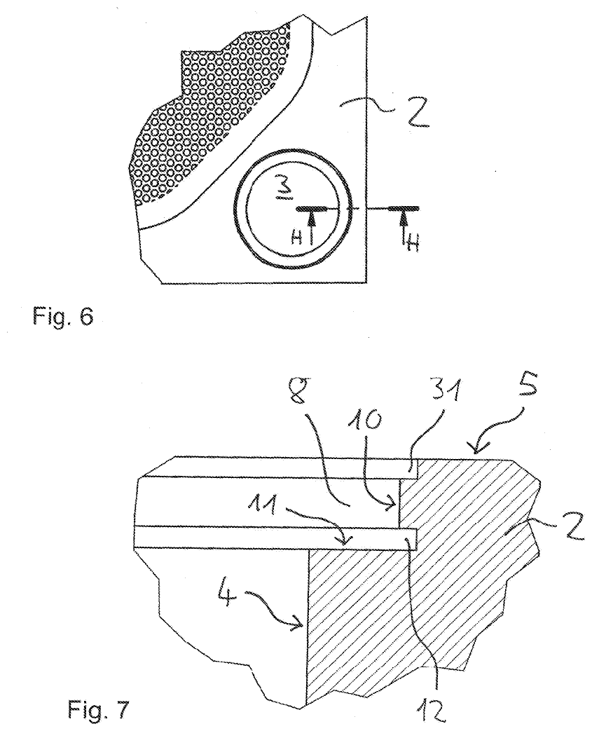

FIG. 6 shows a detailed view of an exemplary embodiment of the filter plate according to the invention,

FIG. 7 shows the sectional view H-H of FIG. 6,

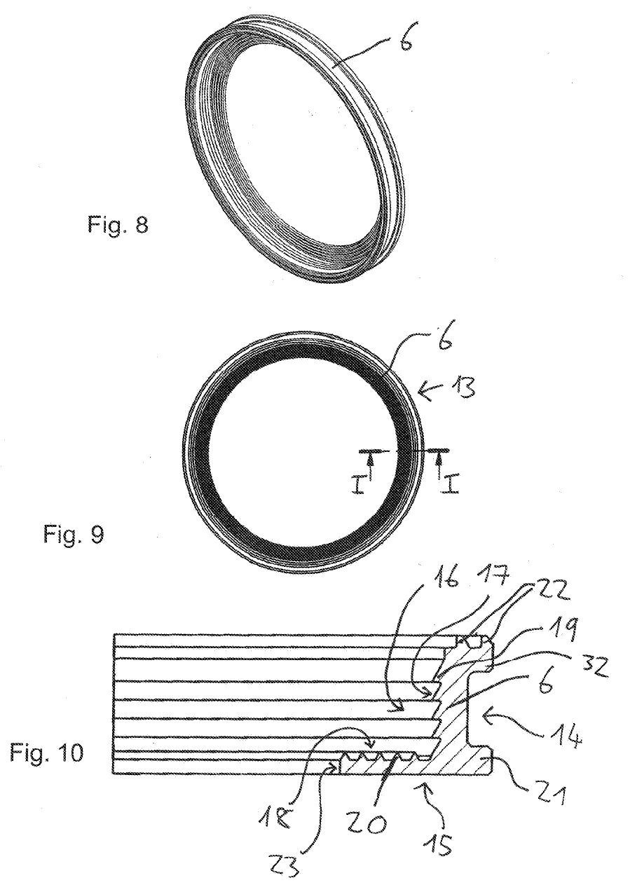

FIG. 8 shows a perspective view of the ring seal of the arrangement according to an exemplary embodiment of the invention,

FIG. 9 shows a view from above of the ring seal shown in FIG. 8,

FIG. 10 shows the sectional view I-I of FIG. 9,

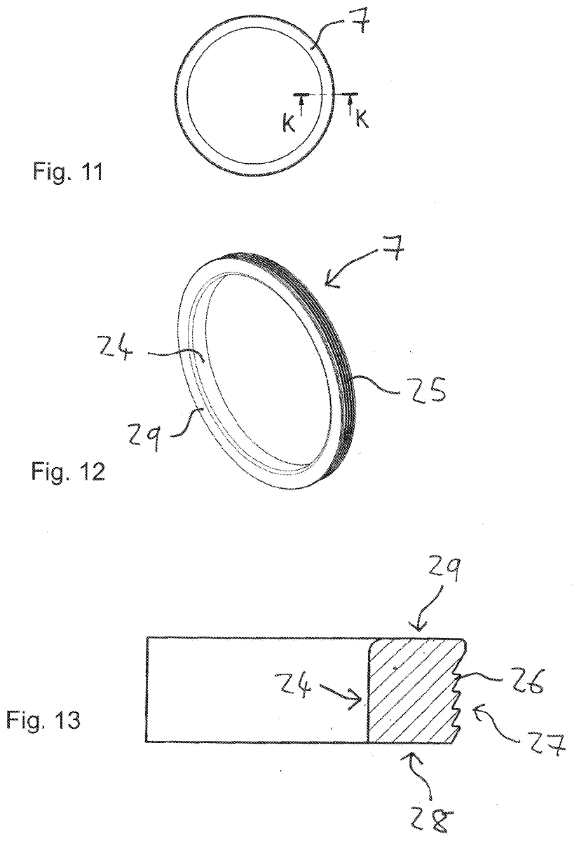

FIG. 11 shows a clamping ring of the arrangement according to the exemplary embodiment of the invention in a plan view,

FIG. 12 shows the clamping ring of FIG. 11 in a perspective view and

FIG. 13 shows a section K-K of FIG. 11.

The arrangement according to the invention comprises a filter plate 1 for a filter press and a sealing device which comprises a ring seal 6 and a clamping ring 7. When the filter plate 1 is used in a filter press, several filter plates 1 are arranged next to each other in such a way that the radially outer sealing edges 2 abut on each other in a sealing manner. A total of four channel openings 3 are formed at the outer corners of the filter plate 1. Furthermore, an opening 30 is formed in the middle. When the filter plate 1 is used in a filter press, the channel openings 3 and the opening 30 of adjacent filter plates 1 lie flush with each other such that channels are formed. These are inlet channels and outlet channels. The suspension to be filtered is fed via the inlet channels to the filter chambers formed by the filter plates 1. The filtrate is led out of the filter plate 1 via the outlet channels.

In the following, the arrangement 1 according to the invention is explained in the case of one of the channel openings 3 shown in FIGS. 1 and 2. However, the arrangement according to the invention can also be used in the same way in the case of other channel openings. These channel openings can be formed for both the inlet channel and the outlet channel.

With reference to FIGS. 3 to 5, the sealing device arranged at the channel opening 3 is described:

If the filter plate 1 extends in the x-y plane (see FIG. 2), the axial direction of the channel opening 3 is the z-direction (see FIG. 3). The channel opening 3 is formed by channel surfaces 4 of the sealing edge 2 of the filter plate 1. The channel surface 4 is circular in cross-section. The channel opening 3 formed by the channel surface 4 passes through the sealing edge 2 of the filter plate 1 perpendicularly to the plane formed by the filter plate 1, i.e. in the axial direction (z-direction).

An annular recess 8 is formed at the transition from the channel surface 4 to the contact surface 5. This annular recess 8 is substantially square in cross-section. It is delimited by a first annular boundary surface 9 of the filter plate 1.

The sealing device is inserted into the recess 8, said sealing device having an elastic ring seal 6 and a clamping ring 7. By way of example, the elastic ring seal 6 consists of an elastomer, for example rubber. The clamping ring 7 is rigid. It consists of a plastic or a metal, for example steel.

The ring seal 6 is angular. One side of the angle extends in the z-direction, i.e. perpendicular to the contact surface 5. The other side extends in parallel to the x-y plane, i.e. in parallel to the contact surface 5. The ring seal 6 has a rib 21 at the apex, which extends in parallel to the contact surface 5 into the sealing edge 2 of the filter plate 1. A groove is formed in the sealing edge 2 for this purpose, as will be explained later. The side of the angular ring seal 6, which is aligned in parallel to the contact surface 5, ends at an end face 23, which is aligned with the channel surface 4. On the end face of the other side of the ring seal 6, which extends in the z-direction, sealing projections 22 are formed on the end face, which project beyond the contact surface 5.

Like the ring seal 6, the clamping ring 7 is formed annularly. The cross-section of the clamping ring 7 is substantially square. It is inserted into the recess 8 in such a way that the elastic ring seal 6 is clamped between the clamping ring 7 and the first annular boundary surface 9 of the filter plate 1. The side surface 24 of the clamping ring 7 is aligned with the channel surface 4 and the end face 23 of the ring seal 6. The other side surface 29 of the clamping ring 7 is aligned with the contact surface 5 of the filter plate 1, such that the sealing projections 22 of the ring seal 6 protrude between the clamping ring 7 and the sealing edge 2 of the filter plate 1.

With reference to FIGS. 6 and 7, the geometry of the filter plate 1 according to the invention, which is used in the arrangement according to the invention, is explained in detail:

The channel opening 3 is formed in the sealing edge 2 of the filter plate 1. It is shown in a partial sectional view in FIG. 7. At the transition from the channel surface 4 to the contact surface 5, where an annular edge is formed in conventional filter plates 1, an annular recess 8 is cut out. The cross-section of this annular recess 8 is substantially square. The recess 8 is limited by the first annular boundary surface 9 at the sealing edge 2 of the filter plate 1. This first annular boundary surface 9 has a second partial surface 10 which runs perpendicularly to the plane formed by the filter plate 1, i.e. parallel to the channel surface 4. Furthermore, the first annular boundary surface 9 has a first partial surface 11 which runs in parallel to the plane formed by the filter plate 1, i.e. the x-y plane. The second partial surface 10 has a groove 12 which extends into the filter plate 1. The direction of the depth of the groove 12 is parallel to the contact surface 5. Furthermore, the second sub-surface 10 has an incision 31 with a square cross-section at the transition to the contact surface 5.

The filter plate 1 can also have corresponding recesses in other channel openings, in particular for the inlet and/or outlet duct.

With reference to the FIGS. 8 to 10, the elastic ring seal 6 is explained in detail:

The ring seal 6 has a second annular boundary surface 13 on the outside. The geometry of this second annular boundary surface 13 corresponds to the geometry of the first annular boundary surface 9 of the filter plate 1. As can be seen from the cross-sectional view in FIG. 10, the second annular boundary surface 13 has a first partial surface 14 on one side, which is aligned to be perpendicular to the contact surface 5. At the apex, a rib 21 is formed on this first partial surface 14, which corresponds to the groove 12 of the filter plate 1. The rib 21 is accommodated in the groove 12 when the ring seal 6 is inserted into the filter plate 1. Furthermore, at the end of the second partial surface 14 of this side, which is aligned parallel to the channel surface 4, a projection 32 is formed adjacent to the contact surface 5 of the filter plate 1, which fits into the corresponding incision 31 of the recess 8. The sealing projections 22 are formed at the end face of the side aligned parallel to the channel surface 4.

The second annular boundary surface 13 also has a second partial surface 15 on the other side, which corresponds to the second partial surface 11 of the first annular boundary surface 9 of the filter plate 1. This side ends with the end face 23, which is aligned with the channel surface 4 when the ring seal 6 is inserted into the filter plate 1.

On the inside, the ring seal 6 has a third annular boundary surface 16, in which locking means are formed. This third annular boundary surface 16 also has a third partial surface 17, which is aligned perpendicularly to the contact surface 5, and a fourth partial surface 18, which is aligned parallel to the contact surface 5. In the third partial surface 17, the latching lugs 19 are formed as latching means, which form an abutment for a movement in the z-direction out of the channel opening 3. In contrast, the fourth partial surface 18 has teeth 20 as latching means.

In the following, the clamping ring 7 is explained in detail with reference to FIGS. 11 to 13:

The clamping ring 7 has a fourth annular boundary surface 25 on the outside, which corresponds to the third annular boundary surface 16 on the inside of the ring seal 6. The fourth annular boundary surface 25 has a third partial surface 27, which is perpendicular to the contact surface 5, and a fourth partial surface 28, which is parallel to the contact surface 5. In the case of the third partial surface 27, latching lugs 26 are formed, which engage in the latching lugs 19 of the ring seal 6 when the clamping ring 7 and the ring seal 6 are inserted in the filter plate 1. In this way, the clamping ring 7 is held in the z-direction in the channel opening 3. The fourth partial surface 28 is formed to be flat. The teeth 20 of the fourth partial surface 18 of the ring seal 6 abut this fourth partial surface 28.

The dimensions of the clamping ring 7 and the ring seal 6 in relation to the recess 8 are selected in such a way that the ring seal 6 fits into the recess 8. Furthermore, the clamping ring 7 can be used with the ring seal 6 in such a way that it compresses the side of the ring seal 6 aligned in the z-direction in the radial direction of the channel opening 3. In this way, the ring seal 6 is clamped between the clamping ring 7 and the first boundary surface 9 of the sealing edge 2 of the filter plate 1. The elastic restoring forces, which are exerted by the ring seal 6 in the radial direction with respect to the channel opening 3, hold the clamping ring 7 in the recess 8. Similarly, the clamping ring 7 is held in the recess 8 in the axial direction with respect to the channel opening 3, i.e. in the z-direction, by the latching means formed by the latching lugs 19 and 26. The latching lugs 19 and 26 are formed in such a way that the clamping ring 7 also presses the side of the ring seal 6, which is aligned parallel to the contact surface 5, against the filter plate 1 in the z-direction, such that a seal against the channel opening 3 is also created in this region.

When the filter plate 1 is used in a filter press, the sealing edge of another filter plate comes into contact with the contact surface 5 of the filter plate 1. By means of the filter press, a force is exerted in z-direction on adjacent filter plates 1, which presses the sealing edges 2 against each other. In the process, the sealing projections 22 are elastically deformed such that they press against the contact surface of an adjacent filter surface and also seal the joint between two adjacent filter plates 1 at the channel formed by the channel openings 3.

By means of the sealing device formed by the clamping ring 7 and the ring seal 6, the channel is effectively sealed against the penetration of solid particles. The geometry of the recess 8 of the filter plate 1 ensures that there is no breakage of the filter plate 1 in the region of the channel opening 3, even if solid particles penetrate into joints. It is also possible to remove the ring seal 6 and the clamping ring 7 in order to clean the joints. Finally, it is possible to match the material of the ring seal 6 and the clamping ring 7 to the use of the filter plate 1 in the filter press. The clamping ring 7 can be made of materials of different strengths. Furthermore, the material of the ring seal 6 can be adapted such that the ring seal 6 has a desired elasticity.

### REFERENCE NUMERAL LIST

1 filter plate

2 sealing edge

3 channel opening

4 channel surface

5 contact surface

6 ring seal

7 clamping ring

8 recess

9 first annular boundary surface

10 second partial surface of the first annular boundary surface

11 first partial surface of the first annular boundary surface

12 groove

13 second annular boundary surface of the ring seal

14 first partial surface of the second annular boundary surface

15 second partial surface of the second annular boundary surface

16 third annular boundary surface of the ring seal

17 third partial surface of the third annular boundary surface

18 fourth partial surface of the third annular boundary surface

19 latching lugs

20 teeth

21 rib

22 sealing projections

23 end face

24 side surface of the clamping ring

25 fourth annular boundary surface of the clamping ring

26 latching lugs

27 third partial surface of the fourth annular boundary surface

28 fourth partial surface of the fourth annular boundary surface

29 side surface of the clamping ring

30 opening

31 incision

32 projection

1. An arrangement of a filter plate for a filter press and of a sealing device,
wherein the filter plate comprises:
a contact surface for contact with a further filter plate, which extends in parallel to a plane (x, y) formed by the filter plate,
at least one channel opening for forming a channel, wherein the channel opening passes through the filter plate perpendicularly to the plane (x, y) formed by the filter plate and is delimited by a channel surface of the filter plate,
an annular recess with a first annular boundary surface at the transition from the channel surface to the contact surface, and
wherein the sealing device comprises:
an elastic ring seal and a clamping ring, wherein the elastic ring seal has a second annular boundary surface which corresponds to the first annular boundary surface, and the clamping ring is designed such that it can be inserted into the annular recess in such a way that the elastic ring seal is clamped between the clamping ring and the first annular boundary surface of the filter plate.

2. The arrangement according to claim 1, wherein the first annular boundary surface has a first partial surface which runs in parallel to the plane (x, y) formed by the filter plate, and a second partial surface which runs perpendicularly to the plane (x, y) formed by the filter plate.

3. The arrangement according to claim 2, wherein a groove is formed on the second partial surface, which extends into the filter plate, and a corresponding rib is formed in the elastic ring seal, said rib engaging in the groove in order to hold the elastic ring seal in the recess in the axial direction (z) of the channel opening.

4. The arrangement according claim 1, wherein the elastic ring seal has a third annular boundary surface with first latching means, wherein the third annular boundary surface is arranged facing away from the second annular boundary surface, and the clamping ring has a fourth annular boundary surface with second latching means, wherein the fourth annular boundary surface faces the third annular boundary surface of the elastic ring seal and corresponds to this.

5. The arrangement according to claim 4, wherein the third annular boundary surface has a third partial surface, which is aligned perpendicularly to the plane (x, y) formed by the filter plate, and the first latching means have latching lugs which are formed on the third partial surface and which hold the clamping ring in the recess in the axial direction of the channel opening.

6. The arrangement according to claim 1, wherein the elastic ring seal accommodated in the annular recess projects with a sealing projection beyond the contact surface of the filter plate.

7. The arrangement according to claim 1, wherein one end face of the elastic ring seal accommodated in the annular recess and one side surface of the clamping ring are aligned with the channel surface.

8. The arrangement according to claim 1, wherein the channel opening is part of an inlet and/or outlet channel.

9. The arrangement according to claim 1, wherein the ring seal consists of an elastomer.

10. The arrangement according to claim 1, wherein the clamping ring is comprised of a plastic material.

11. The arrangement according to claim 1, wherein the clamping ring is comprised of a metal.

12. A filter plate for a filter press, said filter plate comprising:
a contact surface for contact with another filter plate, which extends parallel to a plane (x, y) formed by the filter plate,
at least one channel opening to form a channel, wherein the channel opening passes through the filter plate perpendicularly to the plane (x, y) formed by the filter plate and is delimited by a channel surface of the filter plate, and
an annular recess with a first annular boundary surface at a transition from the channel surface to the contact surface.

13. The filter plate according to claim 12, wherein the first annular boundary surface has a first partial surface which runs in parallel to the plane (x, y) formed by the filter plate, and a second partial surface which runs perpendicular to the plane (x, y) formed by the filter plate.

14. The filter plate according to claim 13, wherein a groove is formed on the second partial surface, which extends into the filter plate.

15. The filter plate according to claim 14, wherein a direction of the depth of the groove is aligned in parallel to the contact surface.

16. The filter plate according to claim 13, wherein an incision is formed on the second partial surface at the transition to the contact surface.
